(19) United States
(12) Patent Application Publication
(10) Pub. No.: US 2013/0008842 A1
(43) Pub. Date: Jan. 10, 2013

(54) CATCH BASIN INSERT

(76) Inventors: Ernest Jarvis, Jr., Norco, CA (US); Rafael Roy Padilla, Yucaipa, CA (US)

(21) Appl. No.: 13/178,751

(22) Filed: Jul. 8, 2011

(51) Int. Cl. B01D 35/28; B01D 35/30

(52) U.S. Cl. 210/232; 210/499

(57) ABSTRACT

A screen system having a body with a frame, the frame having a bottom member, a top member; a plurality of vertical members coupled to the bottom member and the top member; a plurality of vertical bypass members coupled to the top member; and a top coupled to the plurality of vertical bypass members; wherein a screen having a plurality of openings is coupled to the bottom member, the top member and the plurality of vertical members to form a containment portion.

### BACKGROUND OF THE INVENTION

This invention relates generally to storm drain system catch basins, and more particularly, to screen systems for installation in storm drain system catch basins.

The storm drain system is a vast network of underground pipes and open channels that were designed to prevent flooding of city streets. Rain water and ground water runoff drains from the street into a gutter and enters the storm drain system through an opening in the curb called a storm drain inlet. Typically, the storm drain inlet allows water to run into a catch basin from the street. Catch basins typically have an opening and an outlet pipe that provides a path for the water to run from the catch basin to the remainder of the storm drain system. The water then typically runs to a receiving water body.

In addition to runoff, trash and debris can enter the catch basins through the storm drain inlet. Many conventional catch basins have no means for filtering out the debris before the debris passes through the catch basin and runs into the remainder of the storm drain system and on to the receiving water body. This can result in street debris and trash making its way to and polluting the receiving water body.

Accordingly, there is a need for an improved means for filtering out debris that enters a catch basin before the debris makes its way into the remainder of the storm drain system.

### SUMMARY OF INVENTION

The present invention satisfies this need. The invention is a screen system for placement inside a catch basin. The screen system permits water to flow therethrough and prevents solid objects of predetermined size and shape from passing therethrough into an outlet of a storm drain catch basin. In an embodiment of the present invention, the screen system comprises a body having a frame comprising a bottom member, a top member; and a plurality of vertical members coupled to the bottom member and the top member. A plurality of vertical bypass members are coupled to the top member; and a top is coupled to the plurality of vertical bypass members. A screen having a plurality of openings is coupled to the bottom member, the top member and the plurality of vertical members to form a containment portion.

Optionally, the containment portion may further comprise a horizontal brace coupled to the plurality of vertical members. At least two of the vertical members and at least two of the vertical bypass members may each further comprise a flange, wherein the flange further comprises at least one mounting hole for mounting the screen system to the wall of a catch basin. The mounting holes may be keyhole shaped.

In an embodiment, the top further comprises an access module, the access module further comprising a door moveable between a closed position and an open position. The moveable door may be opened more than 90 degrees and may be configured to remain in the open position unless moved by hand. Optionally, the moveable door comprises a lock to hold the door in the closed position.

In an embodiment of the present invention, the access module further comprises: an inner frame having two flanges, each inner frame flange further comprising a pivot pin coupled thereto; a top screen mounted to the inner frame; and an outer frame having two flanges, each outer frame flange further comprising a pivot hole. The pivot pins are mounted in the pivot holes to rotatably couple the inner frame to the outer frame. The outer frame further may have a stop for limiting rotation of the inner frame relative to the outer frame. Optionally, the inner frame has a plurality of protrusions and the outer frame has a plurality of detents, the protrusions and detents being configured to maintain the inner frame in a closed position.

In an additional embodiment of the present invention, the screen system further comprises a plurality of extensions moveably coupled to the bottom member, the extensions having a plurality of holes. At least one of the extensions may have an angled portion such that the screen system is configured for placement in a catch basin having a sloping floor. At least one of the extensions may have a rounded portion such that the screen system is configured for placement in a catch basin having a rounded floor.

In an embodiment of the present invention, the body is substantially U-shaped and has four vertical members and four vertical bypass members. In an alternative embodiment of the present invention, the body is substantially L-shaped and has three vertical members and three vertical bypass members.

### BRIEF DESCRIPTION OF THE DRAWINGS

The features, aspects and advantages of the present invention will become better understood with regard to the following description, appended claims and accompanying figures wherein:

FIG. 1 is a perspective view of a catch basin insert according to an embodiment of the present invention installed in a typical catch basin;

FIG. 2 is an outside perspective view of a catch basin insert according to a first embodiment of the present invention;

FIG. 3 is an outside perspective view of a frame of the catch basin insert of FIG. 2;

FIG. 4 is an inside perspective view of a containment portion of the catch basin insert of FIG. 2;

FIG. 5 is an exploded view of a top of the catch basin insert of FIG. 2.

FIG. 6 is an outside perspective view of the catch basin insert of FIG. 2 with extensions;

FIG. 7 is an outside perspective view of a catch basin insert according to a second embodiment of the present invention; and

FIG. 8 is a perspective view of the inside of a containment portion of the catch basin insert of FIG. 7.

### DETAILED DESCRIPTION OF THE PREFERRED EMBODIMENTS

In the following description of the preferred embodiments, reference is made to the accompanying drawings which show by way of illustration specific embodiments in which the invention may be practiced. Wherever possible, the same reference numbers will be used throughout the drawings to refer to the same or like parts. It is to be understood that other embodiments may be utilized and structural and functional changes may be made without departing from the scope of the present invention.

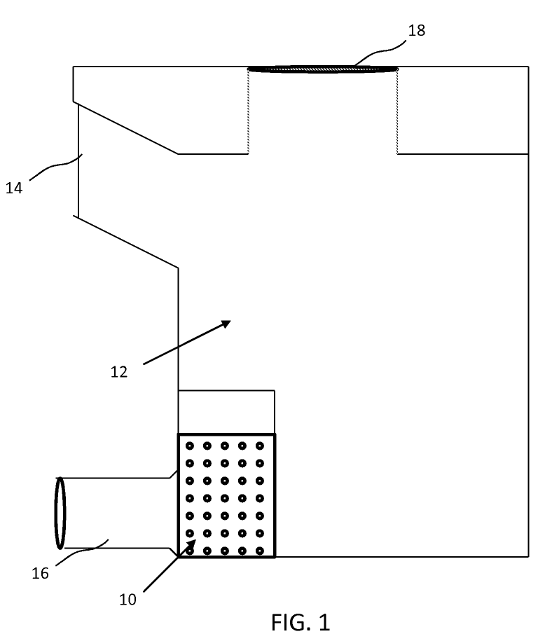

The present invention is an insert for a catch basin. FIG. 1 illustrates a first embodiment of the catch basin insert 10 of the present invention installed inside a conventional storm drain catch basin 12. The conventional storm drain basin 12 has a storm drain inlet 14 and an outlet pipe 16. A manhole 18 may be present to provide access to the storm drain catch basin. Preferably, the catch basin insert 10 is positioned adjacent the outlet pipe 16. However, the catch basin insert 10 may also be positioned adjacent the inlet 14 or at some other point between the insert 14 and the outlet pipe 16.

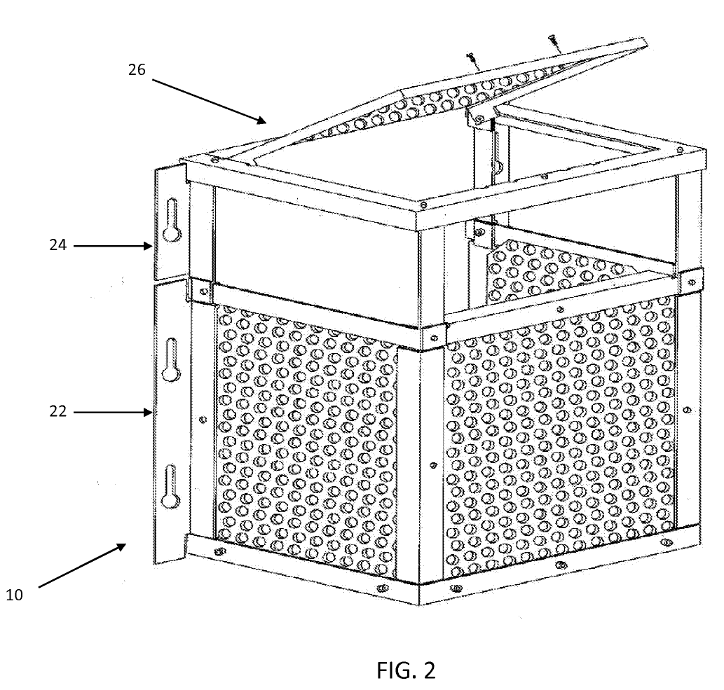

FIG. 2 shows a perspective view of the first embodiment of the catch basin insert 10 of the present invention. The catch basin insert 10 has a substantially u-shaped body 20 with a containment portion 22 and a bypass portion 24. A top 26 is coupled to the body 20. The body 20 has a frame 28 formed from a plurality of frame members and a screen 30 mounted to the frame 28 to form the containment portion 22. Optionally, the frame 28 may be formed from a single piece of material.

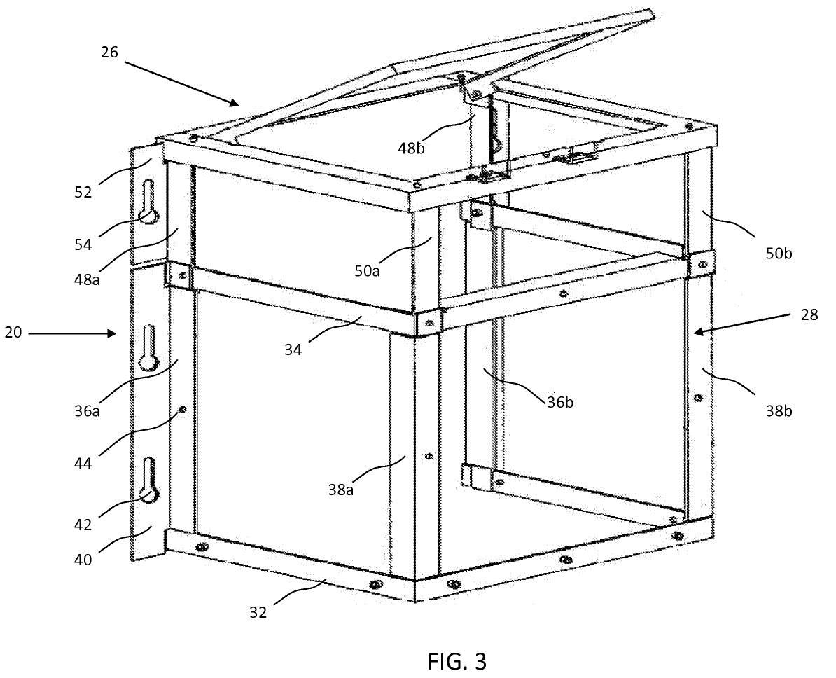

FIG. 3 shows a perspective view of the frame 28 of the first embodiment without the screen 30. The containment portion 22 has a bottom member 32 and a top member 34 which are substantially U-shaped. The bottom member 32 and the top member 34 may be formed from single pieces of material provided with a U-shape. Four vertical members, two rear vertical members 36a, 36b and two front vertical members 38a, 38b connect the bottom member 32 and the top member 34. Each of the vertical members is welded to the bottom member 32 and the top member 34. Alternatively, the vertical members may be attached to the bottom member 24 and the top member 26 by fasteners such as screws or rivets.

Each rear vertical member 36a, 36b has an outwardly extending flange 40, the flange 40 being configured to sit against a wall of the catch basin. Each flange 40 has a plurality of mounting holes 42 which engage with posts or fasteners (not shown) in the wall of the catch basin to mount the catch basin insert 10 to the wall of the catch basin. Preferably, the mounting holes 42 are keyhole shaped, such that the post in the wall of the catch basin is introduced into a first portion of the keyhole having a large diameter and the body 20 is moved relative to the post such that the post then travels into a second portion of the keyhole having a smaller diameter to lock the catch basin screen 10 to the wall of the catch basin. The keyhole is advantageous in allowing for relatively quick, easy and toolless removal of the catch basin insert 10 by moving the catch basin insert 10 relative to the posts in the wall of the catch basin until the catch basin insert can be disengaged from the posts.

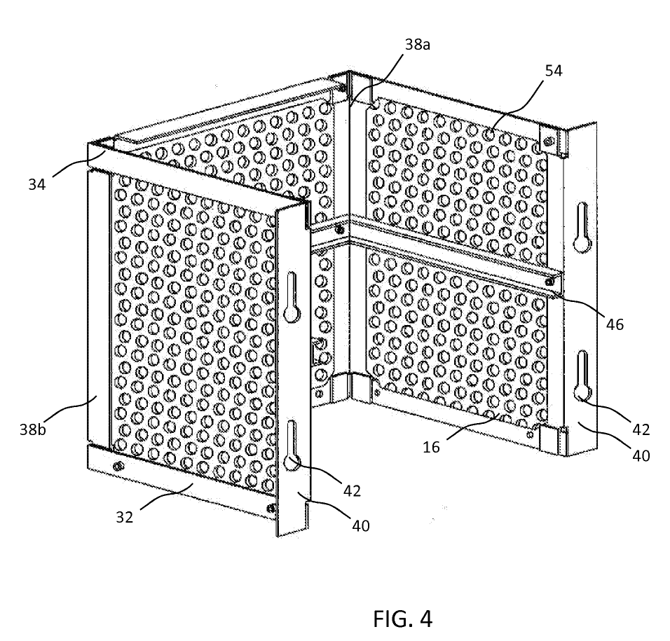

In an embodiment of the present invention, as shown in FIGS. 3 and 4, each of the rear vertical members 36a, 36b and front vertical members 38a, 38b has a support mounting hole 44 for mounting at least one horizontal brace support 46. Preferably, the horizontal brace support 46 is mounted approximately half way between the bottom horizontal member 32 and the top horizontal member 34. It will be understood that the number of horizontal brace supports may be varied and the number of support mounting holes varied to accommodate different numbers of horizontal brace supports. It will also be understood that in certain embodiments, no horizontal brace supports are needed, depending for example on the materials used for the frame members and the screen 30 and the dimensions of the catch basin insert 10.

As shown in FIG. 3, the bypass portion 24 of the first embodiment has four bypass vertical members, two rear bypass vertical members 48a, 48b and two front bypass vertical members 50a, 50b. Each of the bypass vertical members are connected to the top member 34 using a fastener, such as a screw. Optionally, each of the bypass vertical members is welded to the top member 34. Each rear bypass vertical member 48a, 48b has an outwardly extending flange 52 which sits against a wall of the catch basin. Each flange 52 has at least one mounting hole 54 which engages with posts or fasteners in the wall of the catch basin to mount the catch basin screen to the wall of the catch basin. Preferably, the shape of the catch basin mounting holes 52 is the same as that of the containment portion mounting holes 42. Optionally, the catch basin mounting holes 52 are keyhole shaped.

The screen 30 includes a plurality of openings 56. The screen openings 56 permit storm water and ground water to flow therethrough. In the first embodiment, the openings 56 have a sufficiently small dimension to prevent many types of common environmental debris, trash, and pollutants from passing through the screen. Preferably, the screen openings 56 are circular. However, the screen openings may have various other shapes.

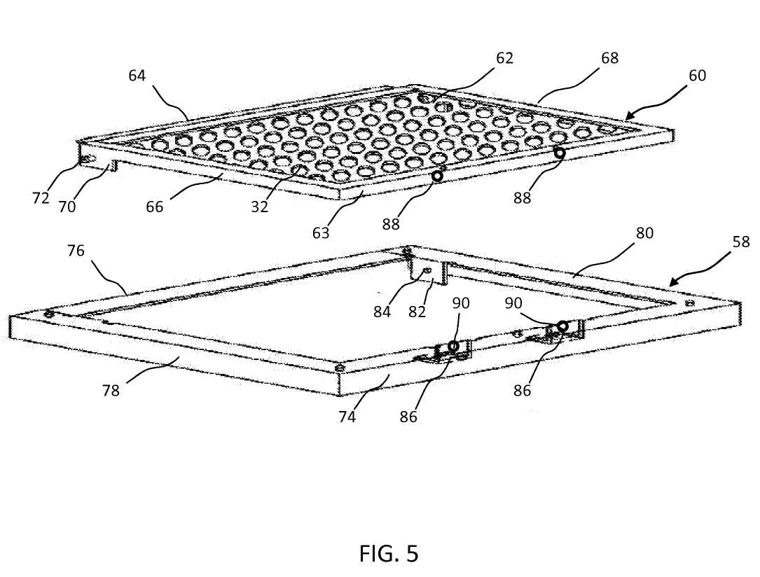

FIG. 5 shows a perspective exploded view of the top 26 according to an embodiment of the present invention. Preferably, the top is 26 is mounted to tops of the rear bypass vertical members 48a, 48b and front bypass vertical members 50a, 50b using a fastener, such as a screw. In alternative embodiments, the top is welded to the vertical members or mounted to the vertical members using an adhesive such as epoxy.

The top 26 has an access module consisting of an outer frame 58, an inner frame 60 and a top screen 62. In an embodiment, the top screen 62 is welded to the inner frame 60. Alternatively, the top screen 62 may be coupled to the sides of the inner frame 60 using fasteners such as screws or an adhesive such as epoxy. In an embodiment, the inner frame 60 is approximately rectangular and has a front 63, a rear 64 and two sides 66, 68. Each of the inner frame sides 66, 68 has a flange 70 proximal to the rear 64. Each flange 70 has a pivot pin 72 coupled thereto.

In an embodiment, the outer frame 58 is approximately rectangular and has a front 74, a rear 76 and two sides 78, 80. Each of the outer frame sides have a flange 82 proximal to the rear 76. Each flange 82 has a pivot hole 84 for receiving the pivot pin 72. The pivot pin 72 and the pivot hole 84 allow for rotatably coupling the inner frame 60 to the outer frame 58.

The outer frame front 74 has at least one stop 86. The stop 86 is configured such that the inner frame cannot rotate down inside of the body 20, even in response to severe pressure from water and debris. Optionally, each outer frame side 78, 80 also has at least one flange for limiting rotation of the inner frame relative to the outer frame.

In an embodiment, the inner frame front 64 has a plurality of protrusions 88 and the outer frame front 74 has a plurality of detents 90 such that when the inner frame 60 is closed within the outer frame 58 an increased friction fit is created to maintain the top in a closed position. In an additional embodiment, the inner and outer frames may have one or more holes and fasteners may be used to lock the inner frame 58 to the outer frame 56 to maintain the top 26 in a closed position. In another embodiment, the inner frame may be fitted with a lock, such as a combination or key lock that allows the top to be locked in a closed position.

In an embodiment, the top screen 62 is coupled to the inner frame 60 such as by welding or fasteners, and the inner frame 60 is then placed in the outer frame 58. The pivot pins 72 are then inserted through the pivot holes 84 in the outer frame and attached, such as through welding, to the inner frame flanges 68. Preferably, the location of the pivot pins 72 and the pivot holes 84 in the outer frame 58 are configured such that the inner frame 60 can be rotated more than 90 degrees relative to the outer frame to an open position where the inner frame 60 will remain in the open position without being held open by a user. This feature is particularly advantageous, because it allows a worker to use both hands to access the inside of the catch basin insert 10 without another device or assistance from another worker.

Preferably, the frame 28 is made from a corrosion resistant metal, such as stainless steel, to withstand the moisture, dirt and abrasion of debris of the catch basin environment. Preferably, the corrosion resistant material is strong enough to prevent the catch basin screen from being compromised by substantial water pressure and impact from debris. In an embodiment, the frame is made from 12 gage stainless steel. Those of skill in the art will recognize the different thicknesses of stainless and alternative materials may also be used. Preferably, the horizontal brace support 46 is also made from 12 gage stainless steel. The horizontal brace support 46 adds support and further secures the screen 30 to the frame 28 to protect the structural integrity of the catch basin insert against severe water force.

The dimensions of the catch basin insert 10 are variable. The height, length, depth and bypass height may all be changed in response to environmental factors such as the dimensions of the catch basin, the amount of debris typically present, the amount of water typically present, and the frequency of cleaning. In an alternative embodiment of the present invention, the body 20 has the containment portion 22, but not the bypass portion 24.

In additional embodiments of the present invention, the top 26 has an area larger than the dimensions of the access module. In an embodiment, the top 26 is approximately square shaped with dimensions of about 10 inches by about 10 inches and the access module therein is approximately square shaped with dimensions of about 8 inches by about 8 inches. The access module allows vertical access to the inside of the catch basin insert 10 for cleaning. Preferably all of the edges of the access module outer frame 58 and inner frame 60 are smooth to avoid damage to a cleanout hose.

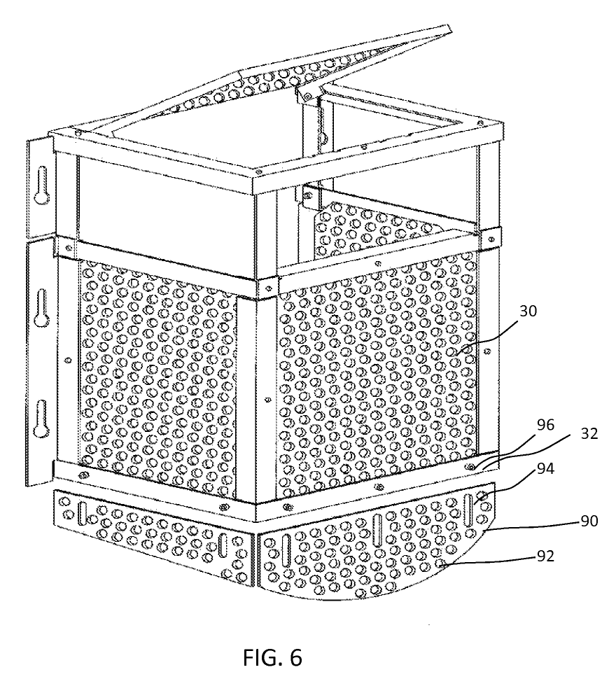

In an additional embodiment of the present invention, as shown in FIG. 6, the catch basin insert is intended for use in catch basins having an angled or rounded bottom. To accommodate angled or rounded catch basin bottoms, the catch basin insert is fitted with adjustable extensions 90 mounted to the bottom member 32 of the containment portion 22. As with the screen 30, the extensions 90 may have holes 92 sized to allow water but not debris to pass through.

The extensions 90 may be made from, for example, 12 gage stainless steel. As will be understood by those of skill in the art, other materials may be used for the extensions depending on the dimensions of the extensions, the shape of the catch basin, and the anticipated amounts of water and debris to which the catch basin insert is likely to be subjected. In a preferred embodiment, the extensions 90 each have a plurality of mounting slots 94 and the extensions 90 are adjustably mountable to the bottom member 32 of the containment portion 22 using a plurality of fasteners 96, such as screws. The use of mounting slots 94 allows for the height of the extensions 90 relative to the bottom member 32 to be varied to accommodate different catch basin dimensions without having to remanufacture the catch basin inserts. The body 20 may also be fitted with a variety of differently sized extensions 90 to accommodate different catch basin dimensions. In an additional embodiment, one or more of the extensions has an angled portion 94 or a rounded portion 96.

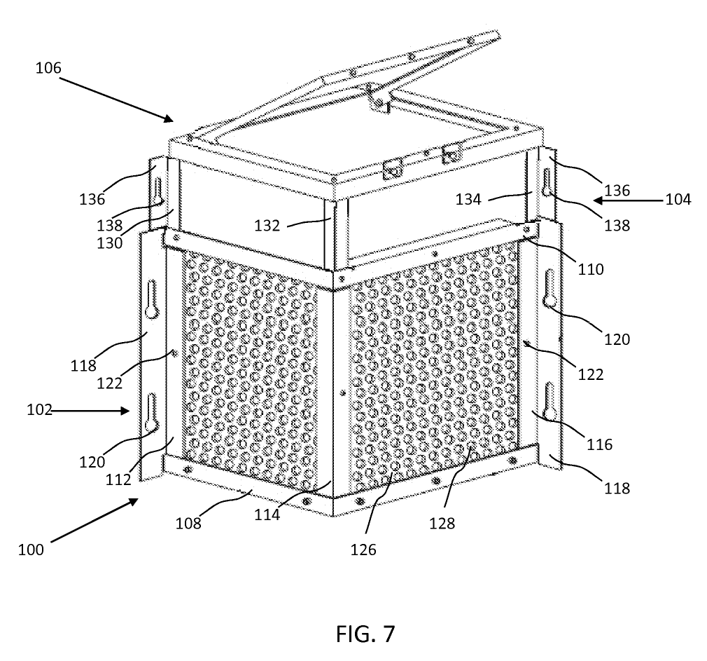

FIG. 7 is a perspective exploded view of a frame of a catch basin insert 100 according to an additional embodiment of the present invention for mounting in a corner of a catch basin. As with the first embodiment, the insert 100 has a containment portion 102, a bypass portion 104 and a top 106. The containment portion 102 has a bottom member 108 and a top member 110 which are substantially L-shaped. The bottom member 108 and the top member 110 may be formed from single pieces of material provided with an L-shape. Three vertical members 112, 114, 116 connect the bottom member 108 and the top member 110. Each of the vertical members 112, 114, 116 is welded to the bottom member 108 and the top member 110. Alternatively, the vertical members 112, 114, 116 may be attached to the bottom member 108 and the top member 110 by fasteners such as screws or rivets.

Vertical members 112 and 116 have an outwardly extending flange 118, the flange 118 is configured to sit against a wall of the catch basin. Each flange 118 has a plurality of mounting holes 120 which engage with posts or fasteners (not shown) in the wall of the catch basin to mount the catch basin insert 100 to the wall of the catch basin. As with the first embodiment, preferably the mounting holes 120 are keyhole shaped.

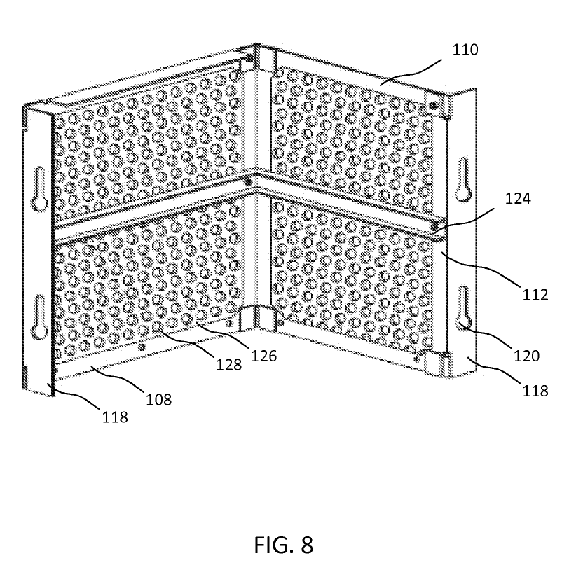

In an embodiment of the present invention, as shown in FIGS. 7 and 8, each of the vertical members 112, 114, 116 has a support mounting hole 122 for mounting at least one horizontal brace support 124. Preferably, the horizontal brace support 124 is L-shaped and mounted approximately half way between the bottom horizontal member 108 and the top horizontal member 110. Again, the number of horizontal brace supports may be varied and the number of support mounting holes varied to accommodate different numbers of horizontal brace supports. In certain embodiments, no horizontal brace supports are needed, depending for example on the materials used for the frame members and the dimensions of the catch basin insert 100. As with the first embodiment, the containment portion 102 also has a screen 126 with a plurality of openings 128.

As shown in FIG. 7, the bypass portion 104 has three bypass vertical members, 130, 132, 134. Each of the bypass vertical members 130, 132, 134 are connected to the top member 110 using a fastener, such as a screw. Optionally, each of the bypass vertical members 130, 132, 134 is welded to the top member 110. Bypass vertical members 130 and 134 have an outwardly extending flange 136 which sits against a wall of the catch basin. Each flange 136 has at least one mounting hole 138 which engage with posts or fasteners in the wall of the catch basin to mount the catch basin screen to the wall of the catch basin. Preferably, the shape of mounting holes 138 is the same as that of the containment portion mounting holes 120. Optionally, the mounting holes 138 are keyhole shaped.

In the embodiment shown in FIG. 7, the top 106 is mounted to tops of the bypass vertical members 130, 132, 134 using a fastener, such as a screw. In alternative embodiments, the top is welded to the vertical members or mounted to the vertical members using an adhesive such as epoxy. Additionally, the top 106 may be mounted to the wall of the catch basin.

Preferably, the top 106 has an access module as detailed above with regard to the first embodiment. However, the top 106 may also be configured without an access module.

There is disclosed in the above description and the drawings, a catch basin insert which fully and effectively overcomes the disadvantages associated with the prior art. However, it will be apparent that variations and modifications of the disclosed embodiments may be made without departing from the principles of the invention. The presentation of the preferred embodiments herein is offered by way of example only and not limitation, with a true scope and spirit of the invention being indicated by the following claims.

Any element in a claim that does not explicitly state “means” for performing a specified function or “step” for performing a specified function, should not be interpreted as a “means” or “step” clause as specified in 35 U.S.C. §112.

What is claimed is:

1. A screen system comprising;
a body having a frame comprising:
a bottom member,
a top member;
a plurality of vertical members coupled to the bottom member and the top member;
a plurality of vertical bypass members coupled to the top member; and a top coupled to the plurality of vertical bypass members;
wherein a screen having a plurality of openings is coupled to the bottom member, the top member and the plurality of vertical members to form a containment portion.

2. The screen system of claim 1 wherein the containment portion further comprises a horizontal brace coupled to the plurality of vertical members.

3. The screen system of claim 1 wherein at least two of the vertical members and at least two of the vertical bypass members each further comprise a flange, wherein the flange further comprises at least one mounting hole for mounting the screen system to the wall of a catch basin.

4. The screen system of claim 3 wherein the mounting holes are keyhole shaped.

5. The screen system of claim 1 wherein the top further comprises an access module, the access module further comprising a door moveable between a closed position and an open position.

6. The screen system of claim 5 wherein the moveable door may be opened more than 90 degrees.

7. The screen system of claim 6 wherein the moveable door is configured to remain in the open position unless moved by hand.

8. The screen system of claim 5 wherein the moveable door further comprises a lock to hold the door in the closed position.

9. The screen system of claim 5 wherein the access module further comprises:
an inner frame having two flanges, each inner frame flange further comprising a pivot pin coupled thereto;
a top screen mounted to the inner frame; and
an outer frame having two flanges, each outer frame flange further comprising a pivot hole;
wherein the pivot pins are mounted in the pivot holes to rotatably couple the inner frame to the outer frame.

10. The screen system of claim 9 wherein the outer frame further comprises a stop for limiting rotation of the inner frame relative to the outer frame.

11. The screen system of claim 10 wherein the inner frame has a plurality of protrusions and the outer frame has a plurality of detents, the protrusions and detents being configured to maintain the inner frame in a closed position.

12. The screen system of claim 1 further comprising a plurality of extensions moveably coupled to the bottom member, the extensions having a plurality of holes.

13. The screen system of claim 12 wherein at least one of the extensions has an angled portion and wherein the screen system is configured for placement in a catch basin having a sloping floor.

14. The screen system of claim 12 wherein at least one of the extensions has an rounded portion and wherein the screen system is configured for placement in a catch basin having a rounded floor.

15. The screen system of claim 1 wherein the body is substantially U-shaped and has four vertical members and four vertical bypass members.

16. The screen system of claim 1 wherein the body is substantially L-shaped and has three vertical members and three vertical bypass members.

17. A screen system comprising;
a substantially U-shaped body having a frame further comprising:
a bottom member,
a top member;
four vertical members coupled to the bottom member and the top member;
a horizontal brace coupled to the vertical members;
four vertical bypass members coupled to the top member; and
a top coupled to the vertical bypass members, the top further comprising:
an inner frame having two flanges, each inner frame flange further comprising a pivot pin coupled thereto;
a top screen mounted to the inner frame; and
an outer frame having two flanges, each outer frame flange further comprising a pivot hole;
wherein the pivot pins are mounted in the pivot holes to rotatably couple the inner frame to the outer frame; and
wherein a screen having a plurality of openings is coupled to the bottom member, the top member and the vertical members to form a containment portion.

18. The screen system of claim 17 further comprising a plurality of extensions moveably coupled to the bottom member, the extensions having a plurality of holes; and at least one of the extensions having an angled portion or a rounded portion such that the screen system is configured for placement in a catch basin having a sloping or rounded floor.

19. A screen system comprising;
A substantially L-shaped body having a frame further comprising:
a bottom member;
a top member;
three vertical members coupled to the bottom member and the top member;
a horizontal brace coupled to the vertical members;
three vertical bypass members coupled to the top member; and
a top coupled to the vertical bypass members, the top further comprising:
an inner frame having two flanges, each inner frame flange further comprising a pivot pin coupled thereto;
a top screen mounted to the inner frame; and
an outer frame having two flanges, each outer frame flange further comprising a pivot hole;
wherein the pivot pins are mounted in the pivot holes to rotatably couple the inner frame to the outer frame; and
wherein a screen having a plurality of openings is coupled to the bottom member, the top member and the vertical members to form a containment portion.

20. The screen system of claim 19 further comprising a plurality of extensions moveably coupled to the bottom member, the extensions having a plurality of holes; and at least one of the extensions having an angled portion or a rounded portion such that the screen system is configured for placement in a catch basin having a sloping or rounded floor.
